(19) United States
(12) Patent Application Publication
(10) Pub. No.: US 2009/0100961 A1
(43) Pub. Date: Apr. 23, 2009

(54) Build-up bicycle pedal

(76) Inventor: Shao-Yuan Hu, Taichung (TW)

Correspondence Address: COOPER & DUNHAM, LLP, 30 Rockefeller Plaza, 20th Floor, NEW YORK, NY, 10112, US

(21) Appl. No.: 11/975,086

(22) Filed: Oct. 17, 2007

(51) Int. Cl. G05G 1/14

(52) U.S. Cl. 74/560

(57) ABSTRACT

A build-up bicycle pedal includes a body and multiple pedal cages. The body is tubular and has a spindle hole and at least one mounting segment. The spindle hole is defined axially through the body. Each mounting segment is formed on the body. The pedal cages are mounted securely on the at least one mounting segment of the body and cover the body. Each pedal cage has a pedal surface having at least one protruding section. The at least one protruding section is formed on the pedal surface. Because the pedal cages can be manufactured by molding of plastics or stamping of metal plates, the pedal cages and the build-up bicycle pedal are lightweight. Additionally, the pedal cages can be manufactured easily and conveniently.

### BACKGROUND OF THE INVENTION

1. Field of Invention

The present invention relates to a bicycle pedal, and more particularly a build-up bicycle pedal that can be manufactured easily and is lightweight.

2. Description of the Related Art

A conventional bicycle pedal comprises a spindle and a pedal body mounted rotatably on the spindle. The conventional pedal body is generally manufactured integrally by casting, forging or extruding to form an intermediate. The intermediate is then machined by a computer numerical control (CNC) machine to form the conventional pedal body.

However, manufacturing the conventional pedal body is troublesome and wastes a lot of time and manufacturing costs of the conventional pedal body is high. Additionally, because the conventional pedal body is manufactured integrally from a solid piece the pedal body is heavy and initial designs must undergo redesigning to reach lightweight requirements of pedal buyers.

To overcome the shortcomings, the present invention provides a build-up bicycle pedal to mitigate or obviate the aforementioned problems.

### SUMMARY OF THE INVENTION

The primary objective of the present invention is to provide a build-up bicycle pedal that can be manufactured easily and is lightweight.

The build-up bicycle pedal comprises a body and multiple pedal cages. The body is tubular and has a spindle hole and at least one mounting segment. The spindle hole is defined axially through the body. Each one of the at least one mounting segment is formed on the body. Each pedal cage is mounted securely on the at least one mounting segment of the body. Each pedal cage has a pedal surface having at least two protruding sections. The at least one protruding section is formed on the pedal surface. Because the pedal cages can be manufactured by molding of plastics or stamping of metal plates, the pedal cages and the build-up bicycle pedal comprising the pedal cages are lightweight. Additionally, the pedal cages can be manufactured easily and conveniently.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a build-up bicycle pedal in accordance with the present invention;

FIG. 2 is an exploded perspective view of the build-up bicycle pedal in FIG. 1;

FIG. 3 is a cross-sectional side view of the build-up bicycle pedal in FIG. 1; and

FIG. 4 is another cross-sectional side view of the build-up bicycle pedal in FIG. 1.

### DETAILED DESCRIPTION OF THE INVENTION

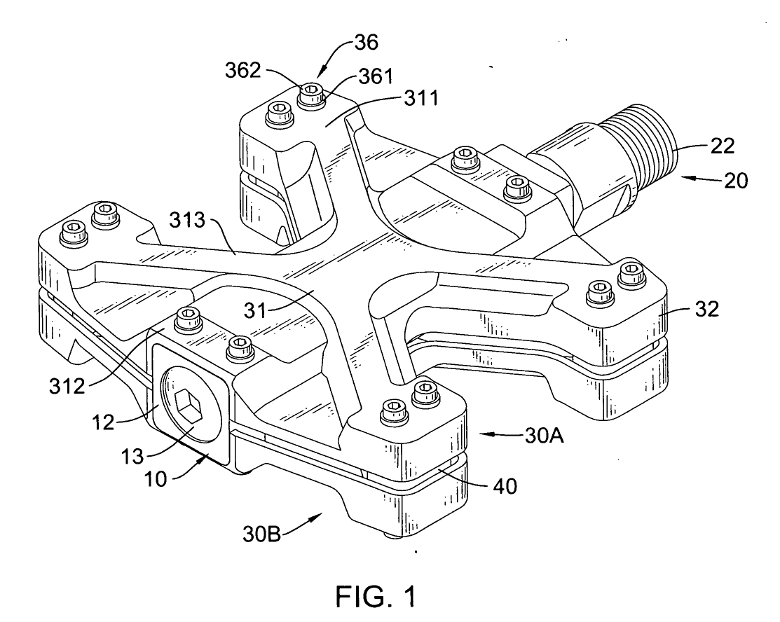

With reference to FIG. 1, a build-up bicycle pedal in accordance with the present invention comprises a body (10), an optional spindle (20), multiple pedal cages (30A, 30B), multiple optional connecting blocks (40) and an optional seal.

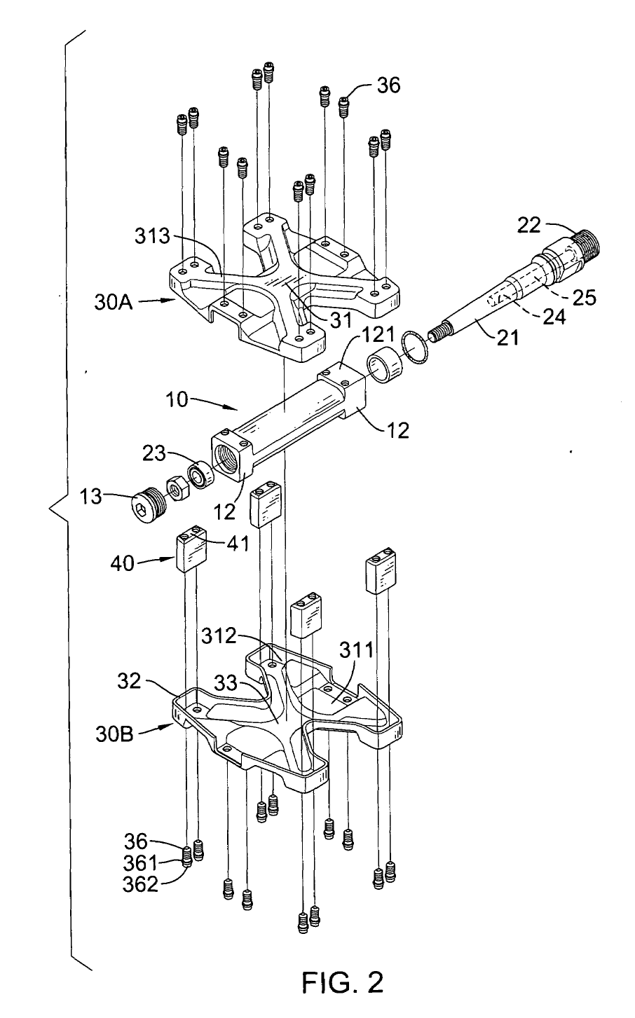

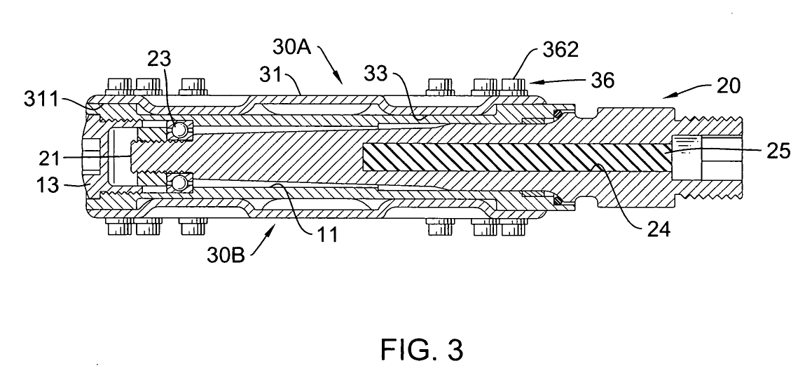

With further reference to FIGS. 2 and 3, the body (10) is tubular, may be approximately as long as the build-up bicycle pedal and has an inner end, an outer end, a spindle hole (11), at least one mounting segment (12) and an optional end fastener (13).

The spindle hole (11) is defined axially through the body (10).

Each one of the at least one mounting segment (12) is formed on the body (10) and may be quadrangular in cross section. Preferably, the body (10) has two mounting segments (12) formed respectively on the inner end and the outer end of the body (10).

The end fastener (13) is mounted in the spindle hole (11) in the outer end of the body (10) to close the spindle hole (11).

The spindle (20) is mounted rotatably in the spindle hole (11) of the body (10) and has a shaft segment (21), a connecting segment (22), at least one bearing (23), an optional receiving chamber (24) and an optional strengthening member (25).

The shaft segment (21) is mounted rotatably in the spindle hole (11) of the body (10).

The connecting segment (22) is formed on and protrudes from the shaft segment (21), protrudes out from the inner end of the body (10) and has an end face and an optional outer thread and is connected securely to a bicycle crank.

Each one of the at least one bearing (23) is mounted around the shaft segment (21) in the spindle hole (11) of the body (10).

The receiving chamber (24) is defined in the end face of the connecting segment (22) and may be circular, triangular, rectangular or star-shaped.

The strengthening member (25) corresponds to and is mounted in the receiving chamber (24) to reduce a weight of the spindle (20) and raise a structural strength of the spindle (20) and may be carbon fiber, polyoxymethylene (POM) or light strengthened metal.

The pedal cages (30A, 30B) are attached securely to the at least one mounting segment (12) using at least one fastener, welding, gluing or embedding, cover the body (10) and may be manufactured by molding plastics or stamping metal plates including aluminum alloy, aluminum magnesium alloy, titanium alloy or light steel. Preferably two pedal cages (30A, 30B) are implemented. The pedal cages (30A, 30B) correspond to each other and each pedal cage (30A, 30B) comprises a pedal surface (31), an optional edge wall (32), an optional mounting cavity (33) and multiple bolts (36).

The pedal surface (31) engages a rider's foot and has an inner surface, an outer surface, an edge, two ends, two sides, a middle, at least one optional body mount (311), at least one protruding section (313) and at least two optional block mounts (312).

The at least one body mount (311) is formed on the inner surface of pedal surface (31) near the middle, correspond respectively to and is attached securely to the at least one mounting segment (12) of the body (10). Preferably two body mounts (311) are implemented.

The at least one protruding section (313) is formed on the pedal surface (31), strengthens the pedal surface (31), provides a distinctive pattern and allows the rider's foot to grip the pedal surface (31). Preferably four protruding sections (313) are implemented. The protruding sections (313) are formed on and protrude oppositely from the middle of the pedal surface (31).

The block mounts (312) are formed respectively on the ends of the pedal surface (31) and may be quadrangular in cross section. Preferably four block mounts (312) are implemented. The block mounts (312) are formed respectively on and protrude from each protruding section (313) at the ends of the pedal surface (31).

The edge wall (32) of each pedal cage (30A) is formed on and protrudes from the edge of the pedal surface (31) and may extend toward the edge wall (32) of another pedal cage (30B).

The mounting cavity (33) is defined between the inner surface of the pedal surface (31) and the edge wall (32).

The bolts (36) are mounted through the pedal cages (30A, 30B) to hold the pedal cages (30A, 30B) on the body (10) and keep the pedal cages (30A, 30B) together. The bolts (36) may comprise a head (361) and a shaft (362). The head (361) protrudes from and abuts the pedal cages (30A, 30B) to provide additional grip to the rider's foot. The shaft (362) is formed on and protrudes coaxially from the head (361) of each bolt (36).

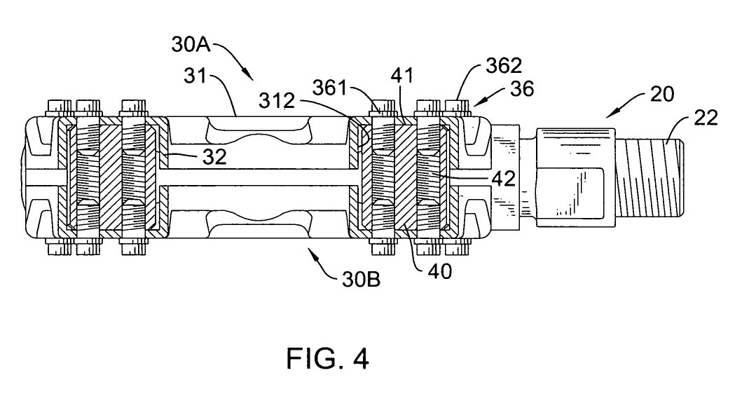

With further reference to FIG. 4, the connecting blocks (40) are mounted between the pedal cages (30A, 30B) respectively in the block mounts (312) to strengthen the pedal cages (30A, 30B). Preferably, four connecting blocks (40) are implemented.

The bolts (36) may be mounted through the block mounts (312) of the pedal cages (30A, 30B) and in the connecting blocks (40) to secure the pedal cages (30A, 30B) together. The bolts (36) may be mounted through the body mounts (311) of the pedal cages (30A, 30B) and in the mounting segments (12) of the body (10) and hold the pedal cages (30A, 30B) on the body (10).

The seal is mounted between the edge walls (32) of the pedal cages (30A, 30B) to prevent water, dust or mud from entering the build-up bicycle pedal and provide distinctive decoration.

Because the pedal cages (30A, 30B) can be manufactured by molding of plastics or stamping of metal plates to form the mounting cavities (33) in the pedal cages (30A, 30B), the pedal cages (30A, 30B) and the build-up bicycle pedal comprising the pedal cages (30A, 30B) are lightweight. Empty space between the pedal cages (30A, 30B) lowers a weight to volume ratio.

Additionally, because the pedal cages (30A, 30B) can be manufactured easily and conveniently, manufacturing procedures can be simplified and the manufacturing costs can be lowered. The body (10) can be detached from the pedal cages (30A, 30B) easily so the body (10) can be replaced or repaired easily. With the protruding sections (313) on the pedal cages (30A, 30B), the pedal cages (30A, 30B) are strengthened and have varied appearances so the build-up bicycle pedal has a high added value.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A build-up bicycle pedal comprising
a body being tubular and having
an inner end;
an outer end;
a spindle hole being defined axially through the body; and
at least one mounting segment being formed on the body; and
multiple pedal cages being attached securely to the at least one mounting segment of the body and covering the body and each pedal cage having a pedal surface having
an inner surface;
an outer surface;
an edge;
two ends;
two sides;
a middle; and
at least one protruding section being formed on the pedal surface.

2. The build-up bicycle pedal as claimed in claim 1, wherein each pedal cage further comprises multiple bolts mounted through the pedal cages and in each one of the at least one mounting segment of the body.

3. The build-up bicycle pedal as claimed in claim 2, wherein each bolt comprises
a head protruding from and abutting one of the pedal cages for providing additional grip to the rider; and
a shaft being formed on and protruding coaxially from the head.

4. The build-up bicycle pedal as claimed in claim 3 wherein the bicycle pedal comprises two pedal cages corresponding to each other and each pedal cage has an edge wall being formed on and protruding from the edge of the pedal surface and extending toward the edge wall of an other pedal cage.

5. The build-up bicycle pedal as claimed in claim 4, wherein
each pedal surface further comprises
at least one body mount being formed on the inner surface of pedal surface near the middle, correspond respectively to and being attached securely to the at least one mounting segment of the body; and
at least two block mounts being formed respectively on the ends of the pedal surface;
the build-up bicycle pedal further comprises at least two connecting blocks being mounted between the pedal cages in the block mounts; and
at least one bolt is further mounted through each block mount of the pedal cages and in each connecting block.

6. The build-up bicycle pedal as claimed in claim 5, wherein
each pedal surface comprises
four protruding sections being formed on and protruding oppositely from the middle of the pedal surface; and
four block mounts being formed respectively on and protrude from each protruding section at the ends of the pedal surface; and
the build-up bicycle pedal comprises four connecting blocks.

7. The build-up bicycle pedal as claimed in claim 6, wherein the body comprises two mounting segments formed respectively on the inner and outer ends of the body; and
each pedal surface comprises two body mounts.

8. The build-up bicycle pedal as claimed in claim 7 further comprising a spindle being mounted rotatably in the spindle hole of the body and having
a shaft segment being mounted rotatably in the spindle hole of the body;
a connecting segment being formed on and protruding from the shaft segment, protruding out from the inner end of the body and having an end face; and
at least one bearing being mounted around the shaft segment in the spindle hole of the body.

9. The build-up bicycle pedal as claimed in claim 8, wherein the spindle further has
a receiving chamber being defined in the end face of the connecting segment of the spindle; and
a strengthening member corresponding to and being mounted in the receiving chamber.

10. The build-up bicycle pedal as claimed in claim 1, wherein the bicycle pedal comprises two pedal cages corresponding to each other and each pedal cage has an edge wall being formed on and protruding from the edge of the pedal surface and extending toward the edge wall of an other pedal cage.

11. The build-up bicycle pedal as claimed in claim 10, wherein
each pedal surface further comprises
at least one body mount being formed on the inner surface of pedal surface near the middle, correspond respectively to and being attached securely to the at least one mounting segment of the body; and
at least two block mounts being formed respectively on the ends of the pedal surface;
the build-up bicycle pedal further comprises at least two connecting blocks being mounted between the pedal cages in the block mounts; and
at least one bolt is further mounted through each block mount of the pedal cages and in each connecting block.

12. The build-up bicycle pedal as claimed in claim 11, wherein each bolt comprises
a head protruding from and abutting one pedal cage for providing additional grip to the rider; and
a shaft being formed on and protruding coaxially from the head.

13. The build-up bicycle pedal as claimed in claim 12, wherein
each pedal surface comprises
four protruding sections being formed on and protruding oppositely from the middle of the pedal surface; and
four block mounts being formed respectively on and protrude from each protruding section at the ends of the pedal surface; and
the build-up bicycle pedal comprises four connecting blocks.

14. The build-up bicycle pedal as claimed in claim 13, wherein
the body has two mounting segments being formed respectively on the inner and outer ends of the body; and
each pedal surface comprises two body mounts.

15. The build-up bicycle pedal as claimed in claim 1 further comprising a spindle being mounted rotatably in the spindle hole of the body and having
a shaft segment being mounted rotatably in the spindle hole of the body;
a connecting segment being formed on and protruding from to the shaft segment, protruding out from the inner end of the body and having an end face; and
at least one bearing being mounted around the shaft segment in the spindle hole of the body.

16. The build-up bicycle pedal as claimed in claim 15, wherein the spindle further has
a receiving chamber being defined in the end face of the connecting segment of the spindle; and
a strengthening member corresponding to and being mounted in the receiving chamber.
